(19) United States
(12) Patent Application Publication
(10) Pub. No.: US 2005/0232508 A1
(43) Pub. Date: Oct. 20, 2005

(54) Plasma display apparatus and image processing method thereof

(75) Inventor: Jun Hak Lee, Suwon-si (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/104,597

(22) Filed: Apr. 13, 2005

(30) Foreign Application Priority Data
Apr. 14, 2004 (KR) 10-2004-0025924

(51) Int. Cl. G06K 9/40

(52) U.S. Cl. 382/264

(57) ABSTRACT

Disclosed herein are a plasma display apparatus and an image processing method thereof for preventing images from blurring when processing the images to improve image quality. The plasma display apparatus includes a low pass filter. The low pass filter includes a filtering value generation part for generating a filtering value to be allocated to the central cell in a block using gray scale values of a video signal, which are allocated to a plurality of cells segmented into unit blocks, a filtering determination part for comparing a difference between the filtering value and the gray scale value of the video signal, which is allocated to the central cell, with a predetermined threshold value to determine whether filtering is performed or not, and a filtering performing part for allocating the filtering value to the central cell when the difference is smaller than the predetermined threshold value.

### BACKGROUND OF THE INVENTION

1. Cross-References to Related Applications

This Nonprovisional application claims priority under 35 U.S.C. § 119(a) on Patent Application No. 10-2004-0025924 filed in Korea on Apr. 14, 2004, the entire contents of which are hereby incorporated by reference.

2. Field of the Invention

The present invention relates to a plasma display apparatus, and more particularly, to a plasma display apparatus and an image processing method thereof for preventing images from blurring when processing the images to improve image quality.

3. Background of the Related Art

A plasma display apparatus includes a front substrate, a rear substrate, and barrier ribs formed between the front and rear substrates to construct unit cells. Each cell is charged with a main discharge gas such as Ne, He or a mixture of Ne and He (Ne+He) and an inactive gas including a small quantity of Xe. When discharge occurs according to a high-frequency voltage, the inactive gas generates vacuum ultraviolet rays to make phosphor formed between adjacent barrier ribs emit lights to display images. The plasma display apparatus is thin and light and thus it is being spotlighted as a next generation display device.

FIG. 1 illustrates the structure of a conventional plasma display panel. Referring to FIG. 1, the plasma display panel includes a front substrate 100 and a rear substrate 110, which are assembled having a predetermined distance between them. The front substrate 100 is constructed such that a plurality of sustain electrode pairs each consisting of a scan electrode 102 and a sustain electrode 103 are arranged on a front glass 101 corresponding to an image display plane. The rear substrate 110 is constructed in a manner that a plurality of address electrodes 11 3 are arranged, intersecting the plurality of sustain electrode pairs, on a rear glass 111.

The scan electrode 102 and the sustain electrode 103 generate discharge in a discharge cell and sustain lighting of the cell and each of them includes a transparent electrode (a) formed of a transparent ITO (Indium Tin Oxide) and a bus electrode (b) formed of a metal. The front substrate 100 is covered with at least one dielectric layer 104 that restrains discharge current of the scan electrode 102 and the sustain electrode 103 and insulates adjacent electrode pairs from each other. MgO is deposited on the dielectric layer 104 to form a protection layer 105 for facilitating a discharge condition.

The rear substrate 110 includes barrier ribs 112 of a stripe type (or well type) formed thereon in parallel. The barrier ribs 112 form a plurality of discharge spaces, that is, discharge cells. In addition, the plurality of address electrodes 113, which carry out address discharge to generate vacuum ultraviolet rays, are arranged on the rear substrate 110 in parallel with the barrier ribs 112.

R, G and B phosphors 114, which emit visible rays for displaying images when the address discharge occurs, are coated on the rear substrate 110. A dielectric layer 115 for protecting the address electrodes 113 is formed between the address electrodes 113 and the phosphors 114.

FIG. 2 illustrates a method of displaying images of the conventional plasma display apparatus. Referring to FIG. 2, the plasma display apparatus divides one frame into a plurality of sub-fields having different numbers of times of discharge, and makes the plasma display panel emit light during a sub-field period corresponding to the gray scale of an input video signal, to thereby display an image.

Each sub-field is divided into a reset period for generating uniform discharge, an address period for selecting a discharge cell, and a sustain period for representing a gray scale in response to the number of times of discharge. When an image is displayed in 256 gray scales, for example, a frame (16.67 ms) corresponding to 1/60 seconds is divided into eight sub-fields. Each of the eight sub-fields is divided into a reset period, an address period and a sustain period. Here, the sustain period is increases at the rate of 2n(n=0,1,2,3,4,5,6,7) in the respective sub-fields. In this manner, the respective sub-fields have different sustain periods to represent gray scales of an image.

As described above, the plasma display apparatus represents gray scales of an image according to a combination of sub-fields. Thus, the plasma display apparatus may generate a false contour noise in a moving picture when coarse video signal data is input or a noise is added to a video signal. This false contour noise reduces display quality of the plasma display apparatus. Here, a coarse image means a picture having a large luminance difference, displayed for one frame, because of a large gray-level difference between neighboring pixels for one frame.

Methods for removing the false contour noise of a moving picture include a method of segmenting one sub-field to add one or two sub-fields, a method of re-arranging the sequence of sub-fields, a method of preparing sub-fields having different modes, a method of adding a sub-field and re-arranging the sequence of sub-fields, an error diffusion method and so on. When a sub-field is added, however, resolution is difficult to increase and the circuit configuration of the plasma display apparatus becomes complicated for lack of sustain period.

FIG. 3 is a block diagram of the conventional plasma display apparatus. Referring to FIG. 3, the plasma display apparatus includes a reverse gamma correcting unit 310, a gain controller 320, a half tone unit 330, and a sub-field mapping unit 340. The reverse gamma correcting unit 310 reverse-gamma-corrects an input video signal using previously stored gamma data to linearly change a luminance value in response to the gray scale of the video signal.

The gain controller 320 respectively multiplies the RGB video data signals corrected by the reverse gamma correcting unit 310 by a value adjusted by a user or a set maker to control respective gains of the RGB data signals. The user or set maker can set a desired color temperature using the gain controller 320.

The half tone unit 330 minutely controls gray scales using an error diffusion or dithering method to improve the power of representing gray scales of an image. The error diffusion method diffuses an error component of the data from the gain controller 320 to neighboring cells to minutely control the luminance value. For this, the error diffusion method divides the data from the gain controller 320 into an integer part and a prime part and multiplies the prime part by Floy-Steinberg coefficient to diffuse an error to neighboring cells.

The sub-field mapping unit 340 divides the data input from the half tone unit 330 into bits, maps the bits to a predetermined sub-field pattern and provides the data to a data aligning unit 350.

The data aligning unit 350 transforms the data input from the sub-field mapping unit 340 into a form suitable for resolution format of the plasma display apparatus and supplies the transformed data to an address driving IC (not shown) of the plasma display apparatus.

The image processing method of the conventional plasma display apparatus determines whether an input video signal corresponds to a moving image or not based on the average luminance of frames of the input video signal, and thus it can make a wrongly determination. That is, when input video signal data includes a noise, the conventional plasma display apparatus recognizes the noise as data and processes the input data to result in texture deterioration.

To reduce the noise in the video signal data, a low pass filter is added to the plasma display apparatus to remove the noise included in the video signal data. Furthermore, a coarse image is low-pass-filtered to produce a smooth image.

Although the plasma display apparatus using the low pass filter can filter the noise included in the video signal data and coarse image data to improve texture, it generates image blurring.

### SUMMARY OF THE INVENTION

Accordingly, the present invention has been made in view of the above problems occurring in the prior art, and it is an object of the present invention is to provide a plasma display apparatus and an image processing method thereof for preventing images from blurring when processing the images using a low pass filter to improve image quality.

To accomplish the above object, according to one aspect of the present invention, there is provided a plasma display apparatus including a low pass filter comprising: a filtering value generation part for generating a filtering value to be allocated to the central cell in a block using gray scale values of a video signal, which are allocated to a plurality of cells segmented into unit blocks; a filtering determination part for comparing a difference between the filtering value and the gray scale value of the video signal, which is allocated to the central cell, with a predetermined threshold value to determine whether filtering is performed or not; and a filtering performing part for allocating the filtering value to the central cell when the difference is smaller than the predetermined threshold value.

The filtering value is a mean value calculated using the gray scale values of the video signal.

The filtering value corresponds to the intermediate value of the gray scale values of the video signal when the gray scale values are arranged in the order of their magnitudes.

The low pass filter filters at least one of a video signal input from an external device and an image-processed video signal.

The block has a magnitude of N×M where N is 2n+1 and M is 2m+1 (n and m are natural numbers).

The filtering performing unit allocates the gray scale value before filtering to the central cell when the difference is larger than the threshold.

Another aspect of the present invention, there is also provided an image processing method of a plasma display apparatus including a low pass filtering step comprising the steps of: generating a filtering value to be allocated to the central cell in a block using gray scale values of a video signal, which are allocated to a plurality of cells segmented into unit blocks; comparing the difference between the filtering value and the gray scale value of the video signal, which is allocated to the central cell, with a predetermined threshold value to determine whether filtering is performed or not; and allocating the filtering value to the central cell when the difference is smaller than the predetermined threshold value.

The filtering value is a mean value calculated using the gray scale values of the video signal.

The filtering value corresponds to the intermediate value of the gray scale values of the video signal when the gray scale values are arranged in the order of their magnitudes.

At least one of a video signal input from an external device and an image-processed video signal is low-pass-filtered.

The block has a magnitude of N×M where N is 2n+1 and M is 2m+1 (n and m are natural numbers).

The gray scale value before filtering is allocated to the central cell when the difference is larger than the threshold.

The present invention can reduce a noise included in input video signal data and restrain image blurring generated when the video signal data is low-pass-filtered, to improve texture of the plasma display apparatus.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 illustrates the structure of a conventional plasma display panel;

FIG. 2 illustrates a method of displaying images of the conventional plasma display apparatus;

FIG. 3 is a block diagram of the conventional plasma display apparatus;

FIG. 4 is a block diagram of a plasma display apparatus according to an embodiment of the present invention;

FIG. 5 is a block diagram for explaining the operation of a low pass filter according to an embodiment of the present invention;

FIG. 6 is a diagram for explaining a filtering value generating step of an image processing method of the plasma display apparatus according to an embodiment of the present invention; and

FIG. 7 is a diagram for explaining a filtering determination step and a filtering performing step of the image processing method of the plasma display apparatus according to an embodiment of the present invention.

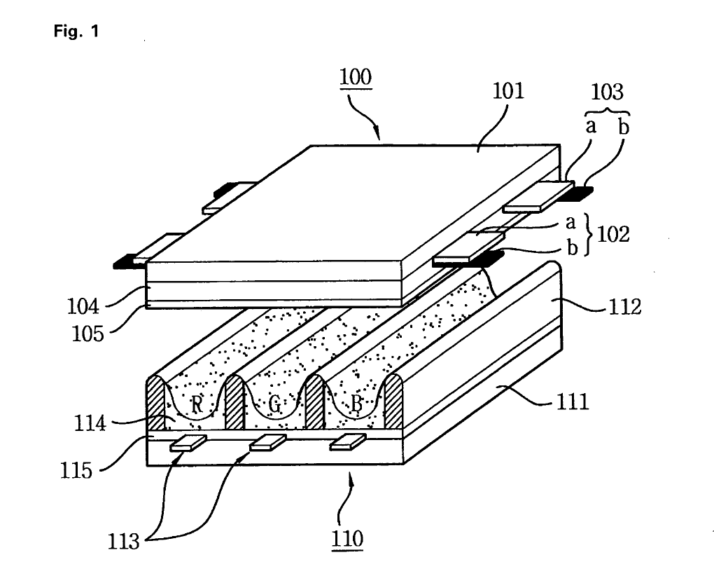

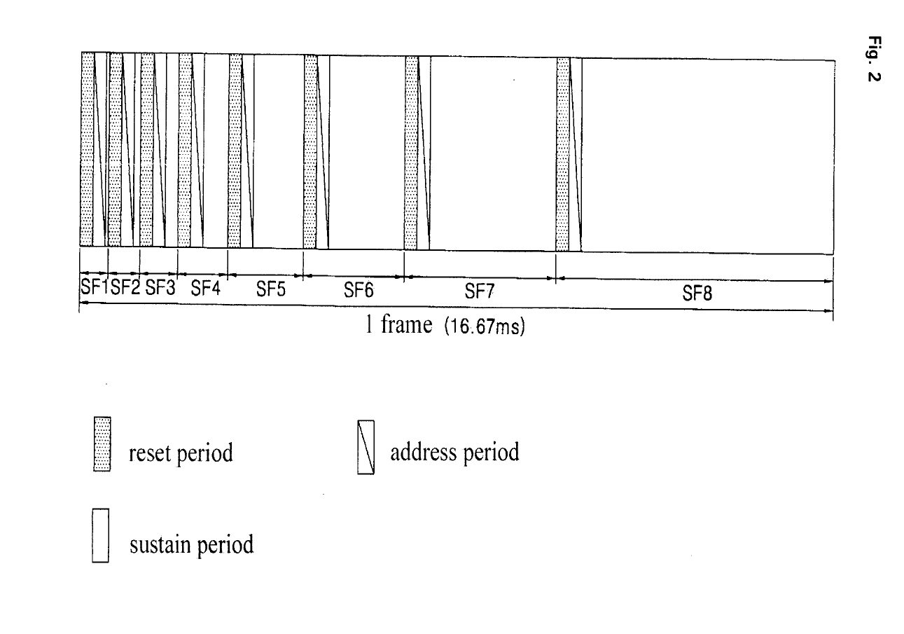

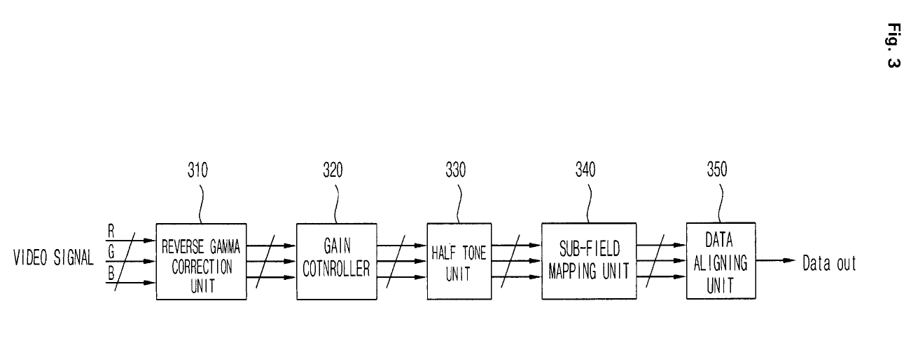

### DETAILED DESCRIPTION OF THE PREFERRED EMBODIMENT

Reference will now be made in detail to the preferred embodiments of the present invention, examples of which are illustrated in the accompanying drawings.

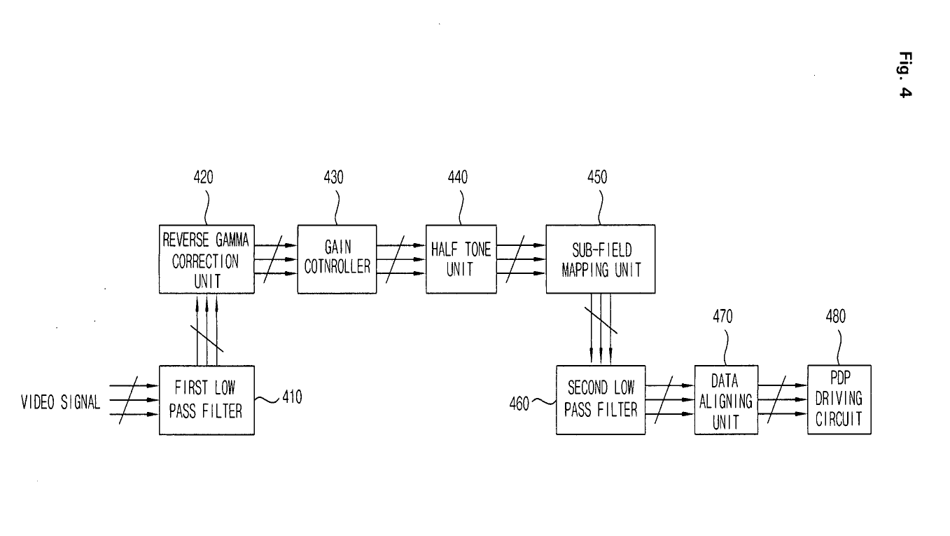

FIG. 4 is a block diagram of a plasma display apparatus according to an embodiment of the present invention. Referring to FIG. 4, the plasma display apparatus according to an embodiment of the present invention includes a first low pass filter 410, a reverse gamma correction unit 420, a gain controller 430, a half tone unit 440, a sub-field mapping unit 450, a second low pass filter 460, and a data aligning unit 470.

The first low pass filter 410 low-pass-filters a video signal input from an external device to remove a noise included in the video signal. To restrain image blurring while removing the noise of the video signal, the first low pass filter 410 includes a filtering value generation part, a filtering determination part and a filtering performing part to determine whether filtering is carried out in response to a predetermined threshold value. In addition, the second low pass filter 460 also removes a noise in the video signal, converts a coarse image into a smooth image, and restrains blurring. Here, the coarse image means a picture having a large luminance difference, displayed for one frame, because of a large gray-level difference between neighboring pixels for one frame. The low pass filters will be explained in more detail later.

The reverse gamma correction unit 420 reverse-gamma-corrects the video signal input from the first low pass filter 410 using previously stored reverse gamma data to linearly change a luminance value in response to the gray scale of the video signal.

The gain controller 430 multiplies the video signal corrected by the reverse gamma correction unit 420, that is, RGB video data, by a predetermined gain value, to set a color temperature desired by a user or a set maker.

The half tone unit 440 minutely controls gray scales using an error diffusion or dithering method to improve the power of representing gray scales of an image. For instance, the error diffusion method diffuses an error component of the data from the gain controller to neighboring cells to minutely control the luminance value. Specifically, the error diffusion method divides the data from the gain controller into an integer part and a prime part and multiplies the prime part by Floy-Steinberg coefficient to diffuse the error component to the neighboring cells.

The sub-field mapping unit 450 divides the data input from the half tone unit 440 into bits and maps the bits to a predetermined sub-field pattern. The second low pass filter 460 filters the data of the video signal input from the sub-field mapping unit 450. That is, the second low pass filter 460 removes a noise generated during an image processing procedure and restrains blurring.

The data aligning unit 470 converts the data input from the sub-field mapping unit 450 into a form suitable for resolution format of the plasma display apparatus and provides the converted data to an address driving IC 480 of the plasma display apparatus.

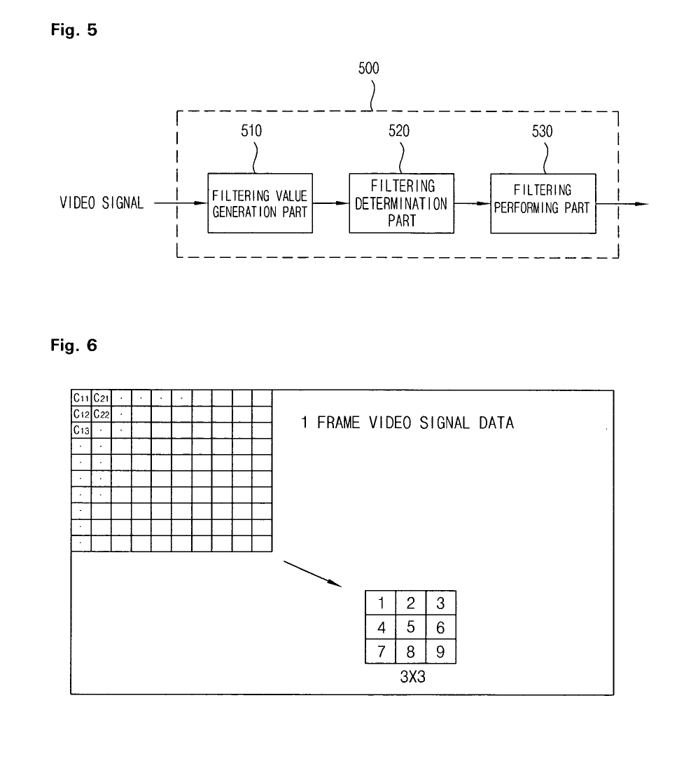

The low pass filters 410 and 460 filter at least one of the input video signal and image-processed video signal. The low pass filters 410 and 460 will now be explained in more detail with reference to FIG. 5. FIG. 5 is a block diagram for explaining the operation of a low pass filter according to an embodiment of the present invention.

Referring to FIG. 5, a low pass filter 500 according to an embodiment of the present invention includes a filtering value generation part 510, a filtering determination part 520, and a filtering performing part 530. The filtering value generation part 510 generates a filtering value to be allocated to the central cell in a block using gray scale values of a video signal, which are allocated to a plurality of cells segmented into unit blocks. Here, the generated filtering value uses one of a mean value or an intermediate value of the gray scale values of the video signal, allocated to the cells in a block. That is, the filtering value can use a mean value calculated using the gray scale values of the video signal, allocated to the cells, or use the intermediate value of the gray scale values of the video signal when the gray scale values are arranged in the order of their magnitudes.

The magnitude of a unit block can be controlled. Here, the unit block has a magnitude of N×M (N is 2n+1 and M is 2m+1) such that it has the central cell.

The filtering determination unit 520 compares the difference between the filtering value and the gray scale value of the video signal, which is allocated to the central cell, with a predetermined threshold value to determine whether filtering is performed out or not.

The low pass filter according to an embodiment of the present invention passes a low-frequency video signal and cuts off a noise included in a high-frequency video signal. When there is a large gray scale difference between neighboring cells, that is, in the case of a coarse image with lots of edges of a video signal, the low pass filter filters a high-frequency component of the video signal to produce a smooth image. However, when the low pass filter filters the edges of the video signal, sharpness of a displayed image is deteriorated to result in blurring.

In consideration of these two aspects, the filtering determination part 520 compares the gray scale value of the central cell with one of the mean value and the intermediate value of the cells in a block to determine whether filtering is carried out or not in response to the predetermined threshold value.

The filtering performing part 530 performs filtering to allocate the filtering value to the central cell when the difference between the filtering value and the gray scale value of the video signal, which is allocated to the central cell, is smaller than the predetermined threshold value. That is, when the difference between the filtering value and the gray scale value allocated to the central cell is smaller than the predetermined threshold value, the filtering performing part 530 determines that the video signal is a noise or a coarse image with an appropriate level and filters the signal to remove a noise and produce a smooth image.

Furthermore, the filtering performing part 530 allocates the gray scale value before filtering to the central cell when the difference between the filtering value and the gray scale value of the video signal, which is allocated to the central cell, is larger than the predetermined threshold value. Accordingly, the filtering performing part 530 determines that the video signal corresponds to the boundary of an object, displayed in an image, having a distinct gray scale value, and thus it does not carry out filtering. That is, the original gray scale value is allocated to the central cell such that the displayed image maintains sharpness and blurring is restrained.

FIG. 6 is a diagram for explaining a filtering value generating step of an image processing method of the plasma display apparatus according to an embodiment of the present invention. Referring to FIG. 6, in an image in which video signal data is input to a plurality of cells to construct one frame, the plurality of cells are segmented into unit blocks. Here, each unit block has a magnitude of N×M where N is 2n+1 and M is 2m+1 (n and m are natural numbers) such that it has the central cell. The magnitude of the unit block can be controlled.

Subsequently, a filtering value used for filtering using gray scale values of the cells in the unit blocks is generated. A first method of generating the filtering value according to an embodiment of the present invention uses a mean value calculated using gray scale values of a video signal as the filtering value. For example, when low pass filtering is carried out on a 3×3 block, the mean value of gray scale values corresponding to the first to ninth cells in the block is calculated.

A second method of generating the filtering value according to an embodiment of the present invention arranges the gray scale values of the video signal in the order of their magnitudes and uses the intermediate value of them as the filtering value. For example, when low pass filtering is carried out on a 3×3 block, the gray scale value corresponding to the intermediate value among the gray scale values corresponding to the first to ninth cells in the block is used as the filtering value. It is determined whether filtering is performed or not using the filtering value generated as above and the threshold value.

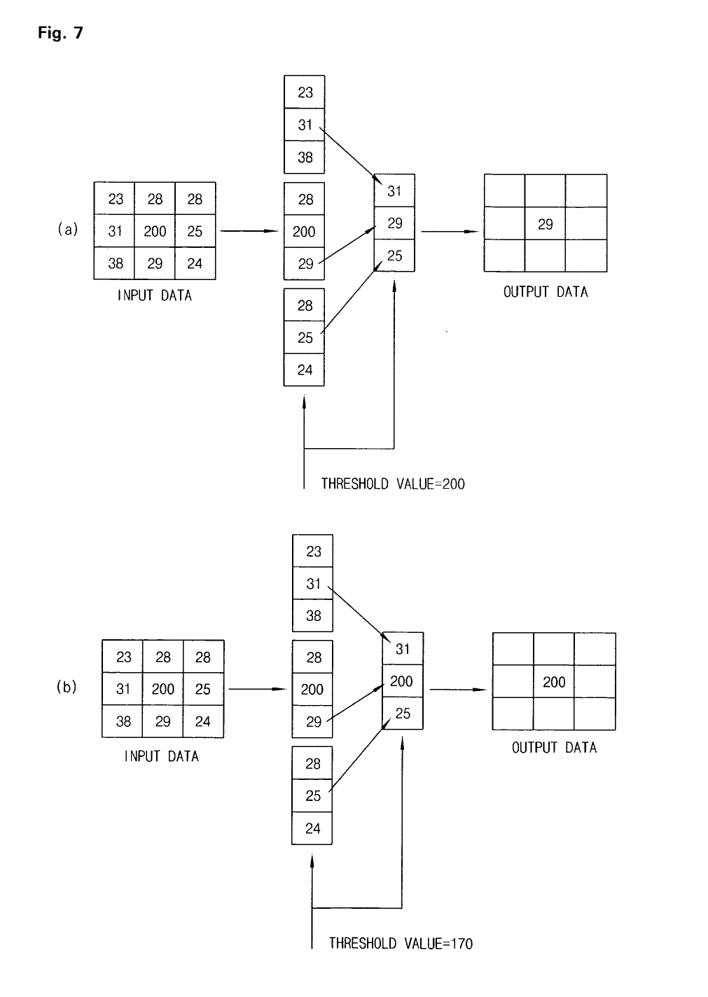

FIG. 7 is a diagram for explaining a filtering determination step and a filtering performing step of the image processing method of the plasma display apparatus according to an embodiment of the present invention. In FIG. 7, the intermediate value is used as the filtering value, and the filtering value is the gray scale value corresponding to the eighth cell, 29.

The difference between the filtering value, 29, and the gray scale value of the central cell, 200, that is, 171, is compared to the threshold value. When the difference, 171, is smaller than the threshold value, 29, is allocated as the gray scale value of the central cell. That is, the gray scale value of the central cell is low-pass-filtered from 200 to 29.

In FIG. 7(a), the threshold value is set to 200. When the filtering value is larger than the threshold value, filtering is not performed. Furthermore, when the filtering value, 171, is larger than the threshold value, 200 is used as the gray scale value of the central cell. That is, the gray scale value of the central cell maintains 200 to restrain blurring.

In FIG. 7(b), the threshold value is set to 170, and thus filtering is not carried out. When the filtering value is smaller than the threshold value, 170, filtering is not performed.

It can be known from FIG. 7 that it is determined whether filtering is carried out or not in response to the threshold value. The number of cells filtered for one frame is increased to obtain a smooth image when the threshold value is large but it is decreased to obtain an image with emphamagnituded sharpness when the threshold value is small.

As described above, the present invention determines that a signal is a noise or a coarse image when the filtering value is smaller than the threshold value and filters the signal to remove a noise and produce a smooth image. On the other hand, when the filtering value is larger than the threshold value, the present invention determines that the signal corresponds to the boundary of an object, which requires to be distinctly represented, and does not carry out filtering to restrain blurring.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A plasma display apparatus including a low pass filter comprising:
a filtering value generation part for generating a filtering value to be allocated to the central cell in a block using gray scale values of a video signal, which are allocated to a plurality of cells segmented into unit blocks;
a filtering determination part for comparing a difference between the filtering value and the gray scale value of the video signal, which is allocated to the central cell, with a predetermined threshold value to determine whether filtering is performed or not; and
a filtering performing part for allocating the filtering value to the central cell when the difference is smaller than the predetermined threshold value.

2. The plasma display apparatus as claimed in claim 1, wherein the filtering value is a mean value calculated using the gray scale values of the video signal.

3. The plasma display apparatus as claimed in claim 1, wherein the filtering value corresponds to the intermediate value of the gray scale values of the video signal when the gray scale values are arranged in the order of their magnitudes.

4. The plasma display apparatus as claimed in claim 1, wherein the low pass filter performs filtering at least one of a video signal input from an external device and an image-processed video signal.

5. The plasma display apparatus as claimed in claim 1, wherein the block has a magnitude of N×M where N is 2n+1 and M is 2m+1 (n and m are natural numbers).

6. The plasma display apparatus as claimed in any one of claims 1 through 5, wherein the filtering performing unit allocates the gray scale value before filtering to the central cell when the difference is larger than the threshold.

7. An image processing method of a plasma display apparatus including a low pass filtering step comprising the steps of:
generating a filtering value to be allocated to the central cell in a block using gray scale values of a video signal, which are allocated to a plurality of cells segmented into unit blocks;
comparing a difference between the filtering value and the gray scale value of the video signal, which is allocated to the central cell, with a predetermined threshold value to determine whether filtering is performed or not; and
allocating the filtering value to the central cell when the difference is smaller than the predetermined threshold value.

8. The image processing method as claimed in claim 7, wherein the filtering value is a mean value calculated using the gray scale values of the video signal.

9. The image processing method as claimed in claim 7, wherein the filtering value corresponds to the intermediate value of the gray scale values of the video signal when the gray scale values are arranged in the order of their magnitudes.

10. The image processing method as claimed in claim 7, wherein at least one of a video signal input from an external device and an image-processed video signal is low-pass-filtered.

11. The image processing method as claimed in claim 7, wherein the block has a magnitude of N×M where N is 2n+1 and M is 2m+1 (n and m are natural numbers).

12. The image processing method as claimed in one of claims 7 through 11, wherein the gray scale value before filtering is allocated to the central cell when the difference is larger than the threshold.
